(19) United States
(12) Patent Application Publication
(10) Pub. No.: US 2015/0207377 A1
(43) Pub. Date: Jul. 23, 2015

(54) ELECTRICAL INDUCTION MOTOR HAVING A ROTOR WITH A BEVEL GEAR ARRANGEMENT FOR DRIVING A PAIR OF OPPOSITE GEAR RINGS

(71) Applicant: MAESTRA ENERGY, LLC, Auburn Hills, MI (US)

(72) Inventor: Miguel A. Linares, Bloomfield Hills, MI (US)

(21) Appl. No.: 14/603,006

(22) Filed: Jan. 22, 2015

Related U.S. Application Data
(60) Provisional application No. 61/930,315, filed on Jan. 22, 2014.

(51) Int. Cl. H02K 5/14; H02K 1/27; H02K 1/24; H02K 16/00

(52) U.S. Cl. CPC H02K 5/143; H02K 16/005; H02K 1/2786; H02K 1/24

(57) ABSTRACT

An induction motor or generator assembly for converting either of an electrical input or rotating work input to a mechanical/rotating work or electrical output. An outer annular arrayed component is rotatable in a first direction and includes a plurality of magnets arranged in a circumferentially extending and inwardly facing fashion according to a first perimeter array, the outer component further incorporating a rotating shaft projecting from a central location. An inner concentrically arrayed and reverse rotating component exhibits a plurality of outwardly facing and circumferentially spaced array of coil-subassemblies opposing the magnetic elements, such that a gap separates the coil-subassemblies from the magnets. The coil sub-assemblies each include a plurality of concentrically arrayed coils configured within a platform support of the inner component. A fixed commutator has a plurality of annular extending and individually insulated segments, a similar plurality of outer rotating brushes in continuous contact with the commutator segments. A spring biased toggle incorporated into the rotatable brush housing influencing each of the outer rotating brushes in a counter-centrifugal force exerting fashion in order to maintain a continuous contact profile with the commutator segments.

### CROSS-REFERENCE TO RELATED APPLICATIONS

This application claims the benefit of U.S. Provisional Application 61/930,315 filed on Jan. 22, 2014, the contents of which is incorporated herein in its entirety.

### FIELD OF THE INVENTION

The present invention relates generally to electrical generators and motors and, more specifically, AC induction generator and motor assemblies for converting an electrical input to a rotating work output. More specifically, the present invention discloses an electrical induction generator or motor exhibiting redesigned stator and rotor components which are reconfigured as outer and inner annular components constructed to rotate in opposite directions during operation and for optimizing work output of the rotating shaft, this further including the integration of a gearbox and gear assembly incorporating oppositely driven rotor and stator supported gears in order to increase work output (i.e. either enhanced rotation of the shaft in an electric motor mode or increased current output in an electric generator mode).

### BACKGROUND OF THE INVENTION

In electricity generation, an electric generator is a device that converts mechanical energy to electrical energy. A generator forces electric current to flow through an external circuit. As is further known, the source of mechanical energy may be a reciprocating or turbine steam engine, water falling through a turbine or waterwheel, an internal combustion engine, a wind turbine, a hand crank, compressed air, or any other source of mechanical energy. In practical applications, generators provide nearly all of the power for electric power grids.

As is further known, the reverse conversion of electrical energy into mechanical energy is done by an electric motor, and motors and generators have many similarities. Many motors can be mechanically driven to generate electricity and frequently make acceptable generators.

Electrical generators and motors (such as of the AC induction or DC variety) typically include an outer stator (or stationary component) which is usually shaped as a hollow cylinder containing copper wires which are wound or otherwise configured within the inner facing wall. In a motor configured application, electricity flowing into selected pairs of coils configured within the stator (a three phase motor typically includes three individual pairs of coils which are arranged in opposing and partially circumferentially offsetting fashion) results in rotation of an interiorly positioned rotor component.

The rotor is usually shaped as a solid cylinder that sits inside the stator (with a defined air gap between the outer cylindrical surface of the rotor and the inner cylindrical surface of the stator) with an output shaft extending from an axial centerline of the rotor. The rotor further includes a series of highly conductive elements (such as aluminum rods) embedded within its outer surface.

In an electric motor driving application, a separate current is fed to the rods via a commutator which is a mechanism used to switch the input of certain AC and DC machines and which usually includes a plurality of slip ring segments insulated from each other and from the rotor shaft. An armature current is supplied through a plurality of brushes (these typically being arranged in a stationary fashion in the prior art) and which are arranged in contact with the rotor supported and revolving commutator, this causing a required current reversal for applying power to the motor in an optimal manner as the rotator rotates from pole to pole (it being noted that the absence of such current reversal would result in the motor braking to a stop).

The stator simulates motion by switching applied current in an overlapping fashion (via the partially overlapping and circumferentially offset sets of coils integrated into the stator inner cylindrical wall). As is further known, the magnetic force created in the stator by energizing the wires or coils is opposed by the armature current supplied rods embedded within the rotor, such that the force of the magnetic field generated in the stator in the multi-phase (staged) fashion results in the driving the current in the rotor supported rods (and therefore the rods and rotor as well) at a right angle to the magnetic field induced, thereby rotating the magnetically suspended (air gap supported) rotor and output shaft at a desired speed without the necessity of any moving components.

In this fashion, magnetic fields are formed in both the rotor and the stator, with the product of these giving rise to the force generated driving torque applied to the (typically inner concentrically supported) rotor. As is further understood, one or both of these magnetic fields (as explained further by Faraday's Law and associated Lorentz Forces Law) must be made to change with the rotation of the motor, such as accomplished by switching the poles on and off at the correct time intervals or by varying the strengths of the poles.

Additional variations of more recent AC electric motors further include either synchronous or asynchronous motors (this again being based upon the speed of rotation of the magnetically generated field under Faraday's Law). In particular, a synchronous electric motor is an AC motor distinguished by a rotor spinning with coils passing magnets at the same rate as the AC and resulting magnetic field which drives it (i.e. exhibiting zero slip under typical operating conditions). In contrast, induction style motors must slip to produce torque and which operate under the principle of inducting electricity into the rotor by magnetic induction (as opposed to by direct electrical connection).

Additional known features include a commutator which is defined as a mechanism used to switch the input of certain AC and DC machines and consisting of slip ring segments insulated from each other and from the electric motor's shaft. In this application, the motor's armature current is supplied through an arrangement of stationary brushes in contact with the (typically) revolving commutator, which causes the required current reversal and applies power to the machine in an optimal manner as the rotor rotates from pole to pole.

Building upon the above explanation, and in an alternate generator application, the rotary shaft is again the input of the rotation by means of an outside work source and, upon being rotated, the configuration of the above-described coils passes by the magnets to create an electrical charge (or field) that becomes the output power variable. An induction generator or asynchronous generator is a type of AC electrical generator that uses the principles of induction motors to produce power.

Induction generators operate by mechanically turning their rotor faster than the synchronous speed, giving negative slip. A regular AC asynchronous motor usually can be used as a generator, without any internal modifications. Induction generators are useful in applications such as mini-hydro power plants, wind turbines, or in reducing high-pressure gas streams to lower pressure, because they can recover energy with relatively simple controls. To operate an induction generator must be excited with a leading voltage; this is usually done by connection to an electrical grid, or sometimes they are self-excited by using phase correcting capacitors.

Other known generator applications include a dynamo which is an electrical generator that produces direct current with the use of a commutator. Dynamos were the first electrical generators capable of delivering power for industry, and the foundation upon which many other later electric-power conversion devices were based, including the electric motor, the alternating-current alternator, and the rotary converter.

Features associated with the commutator include it comprising the moving part of a rotary electrical switch in certain types of electric motors or electrical generators that periodically reverses the current direction between the rotor and the external circuit. Commutators typically have two or more softer (fixed) metallic brushes in contact with them to complete the other half of the switch. In a motor, it applies power to the best location on the rotor, and in a generator, picks off power similarly. As a switch, it has exceptionally long life, considering the number of circuit makes and breaks that occur in normal operation.

Expanding on the above explanation, and as is further known, a commutator consists of a set of copper segments, fixed around the part of the circumference of the rotating machine, or the rotor, and a set of spring loaded brushes fixed to the stationary frame of the machine. Two (or more) fixed brushes connect to the external circuit, either a source of current for a motor or a load for a generator.

Each conducting segment on the armature of the commutator is insulated from adjacent segments through the use of an appropriate material. Many other insulating materials are used to insulate smaller machines; plastics allow quick manufacture of an insulator, for example. In other applications, the segments are held onto the shaft using a dovetail shape on the edges or underside of each segment, using insulating wedges around the perimeter of each commutation segment.

As is further known in the art, a commutator is also a common feature of direct current rotating machines. By reversing the current direction in the moving coil of a motor's armature, a steady rotating force (torque) is produced. Similarly, in a generator, reversing of the coil's connection to the external circuit provides unidirectional (i.e. direct) current to the external circuit.

Without a commutator, a dynamo becomes an alternator, which is a synchronous singly fed generator. Alternators produce alternating current with a frequency that is based on the rotational speed of the rotor and the number of magnetic poles.

Automotive alternators produce a varying frequency that changes with engine speed, which is then converted by a rectifier to DC. By comparison, alternators used to feed an electic power grid are generally operated at a speed very close to a specific frequency, for the benefit of AC devices that regulate their speed and performance based on grid frequency. When attached to a larger electric grid with other alternators, an alternator will dynamically interact with the frequency already present on the grid, and operate at a speed that matches the grid frequency.

Typical alternators use a rotating field winding excited with direct current, and a stationary (stator) winding that produces alternating current. Since the rotor field only requires a tiny fraction of the power generated by the machine, the brushes for the field contact can be relatively small. In the case of a brushless exciter, no brushes are used at all and the rotor shaft carries rectifiers to excite the main field winding.

The armature component of the device must carry current so it is always a conductor or a conductive coil which is oriented normal to both the field and to the direction of motion, torque (rotating machine), or force (linear machine). The armature's role is twofold, the first being to carry current crossing the field, thus creating shaft torque in a rotating machine or force in a linear machine (e.g. motor mode), the second role being to generate an electromotive force (EMF).

In the armature, an electromotive force is created by the relative motion of the armature and the field. When the machine acts in the motor mode, this EMF opposes the armature current, and the armature converts electrical power to mechanical torque, and power, unless the machine is stalled, and transfers it to the load via the shaft.

When the machine acts in the generator mode, the armature EMF drives the armature current, and shaft mechanical power is converted to electrical power and transferred to the load. In an induction generator, these distinctions are blurred, since the generated power is drawn from the stator, which would normally be considered the field.

Applications of electro-magnetic motor and generator assemblies in the patent art include the permanent magnet motor generator set of Strube, US 2010/0013335, which teaches a method of utilizing unbalanced non-equilibrium magnetic fields to induce a rotational motion in a rotor, the rotor moves with respect to the armature and stator. A three tier device (armature, rotor, and stator) has the armature and stator being fixed in position with the rotor allowed to move freely between the armature and stator.

To induce a rotational motion, the rotor, in its concave side uses unbalanced non-equilibrium magnetic fields created by having multiple magnets held in a fixed position by ferritic or like materials to act upon the magnets imbedded in the armature. The rotor, in its convex side has additional unbalanced non-equilibrium magnets and additional pole pair magnets to create a magnetic flux that moves with the moving fixed position fields to cut across closely bonded coils of wire in the stator to induce a voltage and current that is used to generate electrical power. Multiple permanent magnets of varying strength are geometrically positioned in multiple groups to produce a motive power in a single direction with the remainder of the unbalanced magnetic flux positioned and being used to cut across the coils of wire to produce continuous electric power.

Hasegawa, US 2014/0197709, teaches an assembly conducting wire for a rotary electric machine winding which includes a plurality of bundled wires, these being twisted in a circumferential direction, with the wires being welded together at a predetermined distance. US 2007/0096580, to Ketteler, teaches a stator for a three phase current electric machine such as for motor vehicles and which consists of a winding support having grooves and teeth. The windings are arranged in the grooves and the winding support consists of a plurality of identical segments which, after being wound, are shaped into a circular ring. The segments are then inserted into a cylindrical housing and, with their windings, form the cylindrical stator.

Liao, U.S. Pat. No. 7,965,011, teaches a brushless DC motor structure with a constant ratio of multiple rotor poles to slots of the stator and which is characterized primarily by forming the stator of the motor by multiple ferromagnetic silicon steel sheets, where the ferromagnetic silicon steel sheets are provided with the multiple slots whose number is a multiple of 15, and the stator of the motor is formed by windings of the three phases, X, Y, and Z. Each phase includes 2 to 4 phase portions and each group has 5 slots. The rotor of the motor is made up of a plurality of arced magnets which are fixed orderly and equally along a ferromagnetic steel ring, and the radial direction of each arced magnet is opposite to that of the adjacent magnetic poles. An arced magnet represents a magnetic pole, and the number of the magnetic poles is a multiple of 14 or 16, such as for reducing the cogging torque of the motor.

WO 2012/017302, to Kamper/Stellenbosch University, teaches an electrical energy conversion system which is particularly suited for use in wind energy conversion systems. A pair of magnetically separated permanent magnet machines are linked by a freely rotating rotor housing permanent magnets. The first machine is typically a synchronous generator, and the second an induction generator. The synchronous generator has a stationary stator which is connectable to an electrical system such as an electricity grid, and the induction generator has a rotor which is connectable to a mechanical drive system such as a wind turbine.

Kamper, US 2013/0214541, teaches an electrical energy conversion system which is particularly suited for use in wind energy conversion systems. The system includes two magnetically separated permanent magnet machines linked by a freely rotating rotor housing permanent magnets. The first machine is typically a synchronous generator, and the second an induction generator. The synchronous generator has a stationary stator which is connectable to an electrical system such as an electricity grid, and the induction generator has a rotor which is connectable to a mechanical drive system such as, for example, a wind turbine.

Prucher, U.S. Pat. No. 8,247,943 teaches a radial gap motor/generator having a thin annular array of magnets mounted for rotation to a stator in a radially spaced relation to at least one thin annular induction structure fixed to a stationary stator may be air or liquid cooled. The motor has at least radial gap between a magnetic core and the array and may include multiple gaps and multiple annular induction structures to increase the overall power density of the system.

An example of a planetary geared motor and dynamo is shown in Mizushima, U.S. Pat. No. 8,084,912, and which includes provision of planetary gear dynamo for reducing inverse torque when the functioning in a generator mode. Palfai, 2013/0237361, teaches a planetary gear assembly including a ring gear configured for connection to a rotor of an electric motor when in a first position and configured for connection to a housing of the electric motor when in a second position. A sun gear is configured for connection to the housing when the ring gear is in the first position and configured for connection to the rotor when the ring gear is in the second position. A plurality of planet gears are configured to mesh with the ring gear and the sun gear.

Also referenced are the brush holder clip to commutator assemblies shown in each of Southall, U.S. Pat. No. 5,159,222 and Coles U.S. Pat. No. 5,631,513. Coles specifically teaches a brush holder clip and connector for motors and generators provided in the form of an integral V-shaped spring steel member having an electrical connector extending one of the legs thereof and opposite an apex of the clip and connector. The housing containing the commutator has a slot therein through which the brush holder passes. The V-shaped clip and connector is inserted into the slot and wedged between the brush holder and an edge of the slot. The clip and connector is electrically conductive and communicative with the brush holder and is adapted for mating interconnection with a wire or other conductor.

### SUMMARY OF THE INVENTION

The present invention, while drawing from much the existing theory and teachings surrounding electrical motor and generator type conversion assemblies, in particular teaches an AC induction motor assembly for converting an electrical input to a mechanical or rotating work output. A related generator variant converts a rotating work input to a converted electrical output utilizing the same efficiencies achieved by the present design.

An outer annular arrayed component is rotatable in a first direction and an inner annular and concentrically arrayed component rotatable in a second opposite direction, the components separated by an air gap. The outer component exhibits an annular end surface supporting a plurality of magnetic elements in a first circumferentially extending and inwardly facing perimeter array, the outer component further having a rotatable shaft.

The inner component exhibits an outwardly facing and circumferentially spaced second perimeter array of coil-subassemblies, these opposing the magnetic elements of the outer component. The individual coil sub-assemblies each include a plurality of concentrically arrayed coils configured within a platform support of the inner component, and such as which are configured as inner, middle and outer coils.

A fixed commutator has a plurality of annular extending and individually insulated segments, a similar plurality of outer rotating brushes in continuous contact with the commutator segments. A spring biases each of the brushes in a counter-centrifugal force exerting fashion in order to maintain a continuous contact profile with the commutator segments. This can further include a toggle element interposed between each of the springs and brushes and which is balanced about an abutment defined in the brush housing.

The assembly operates in a first variant such that a current supplied to the commutator segments and coil sub-assemblies creates a magnetic field with the outer magnetic array in a desired phased or shifting manner, resulting in relative rotation between the components resulting in a rotating work output delivered to the shaft. The assembly operates in a second generator variant such that a rotating work input supplied to the shaft creates at least opposing magnetic fields between the reverse rotating annular components for creating an electrical current output through the individual coil subassemblies.

Additional features include a gearbox having a sleeve shaped trunk about which are arrayed a pair of upper and lower counter rotating rings, each exhibiting a mitre shaped plurality of teeth, a plurality of reversing gears exhibiting likewise mitre shaped teeth which inter-engage toothed locations of each of the rings. A rotating platform structure is provided, within which the upper ring is integrated, a housing incorporating the outer rotating brushes being secured upon the rotating platform structure.

The outer annular component supporting the inwardly facing magnet perimeter array and the rotatable shaft also includes a lower housing, with the inner annular and counter rotating coil subassembly supporting components including an upper housing. The shaft associated with the outer component extends through a central through aperture associated with the inner component.

Each of the concentrically arrayed plurality of individual coils further includes a plurality of wires wound or braided together. It is further envisioned that the concentrically arrayed coils can be individually wired in any desired configuration and at least one of the wires can have a larger gauge as compared to one or more additional wire.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective of the electrical generator or motor with the upper housing removed according to a non-limiting embodiment of the invention and which exhibits a plurality of circumferentially arranged and inwardly facing magnets associated with a shaft supporting and rotating component, in combination with an inner concentrically arranged and opposing array of individual coil sub-assemblies which are likewise arranged in plural and circumferential fashion about an inner coaxial rotating component which is driven in a direction opposite the outer rotating component, the generator or motor device further depicting an inner coaxial component supported and rotatable brush housing established in continual contact with a fixed interior array of commutator segments for facilitating either rotating shaft or current output of the overall assembly in either motor or generator operational modes;

FIG. 2 is an assembly cutaway of the electric induction motor or generator and better illustrating the arrangement of the outer and inner coaxial and counter rotating components, gearing and commutator/brush components associated with the present inventions;

FIG. 3 is a sectional perspective of the gearbox and gear subassemblies and exhibiting the gearbox and gear assembly incorporating oppositely driven magnet and coil supported mitre gears arranged in order to increase work output (i.e. either enhanced rotation of the shaft in an electric motor mode or increased current output in an electric generator mode);

FIG. 4 is an enlarged and further rotated perspective cutaway similar to FIG. 2, and further depicting the brush housing in a further rotated and cutaway position with spring loaded brush contacting the external annular face of a selected commutator segment and in order maintain continuous contact during rotation of the brush at higher speeds; and

FIG. 5 is a perspective of the inner rotating component exhibiting individual multi-wire coils arranged in a spaced and three stage configuration with intermediate positioned insulating portions and, with the removal of the circumferential array of magnets associated with the outer coaxial rotating component, better illustrates the potential variations in coil geometry and braiding patterns associated with the inner concentrically arranged and opposing array of coil sub-assemblies and which further enhances the performance characteristics of the assembly in either of motor or generator modes of operation.

### DETAILED DESCRIPTION OF THE PREFERRED EMBODIMENTS

As previously described, the present invention relates generally to electrical generators and motors and, more specifically, discloses AC induction generator or motor assemblies for converting into an electrical output a rotating work input applied to a shaft (generator mode) or, alternatively, converting an electrical input applied to the coils and magnets to a rotating work output (motor mode). More specifically, the present invention discloses an electrical induction generator or motor exhibiting redesign stator and rotor components for optimizing either electrical output (generator) of the rotating input applied to the rotor shaft (generator) or, alternately, work output of the rotating shaft resulting from electrical (current) input.

Given the above background description, the present invention discloses an improved arrangement of induction style AC generators or electric motors, in which an outer coaxial and inner facing circumferential array of magnets is incorporated into a redesigned rotor and which is opposed by an inner coaxially positioned and outwardly facing circumferential array of multi-wire wound/braided coil subassemblies respectively incorporated into a redesigned stator. The redesigned aspects of the stator and rotor, in combination with the unique and novel aspects of the individually winding/braiding patterns of the multi-wire and serpentine arranged coil subassembly (or possibly segmented subassemblies), results in either improved electrical output of resulting from the configuration of the coils passing by the magnets to create an electrical charge or, in the alternate electrical motor variant, provides for an optimal work output of the rotor shaft in response to a given electrical input necessary for generating the opposing magnetic fields in the motor components.

Additional novel aspects of the present inventions include the incorporation of a mitre gear and gearbox assembly incorporating first and second rotor and stator supported mitre gear rings, these being further spatially supported and oppositely rotated by a set of, typically a pair, of circumferentially arrayed and offset reversing gears. The effect of the gearbox assembly is to increase either the work output of the shaft in a motor configuration or the current generating and electrical output delivery capability of the armature in the generator configuration, this by assisting in the counter rotation of a coil segment supported and inner coaxial supporting component (traditionally the rotor) relative to the counter rotated and outer coaxial magnet supported component (traditionally the stator).

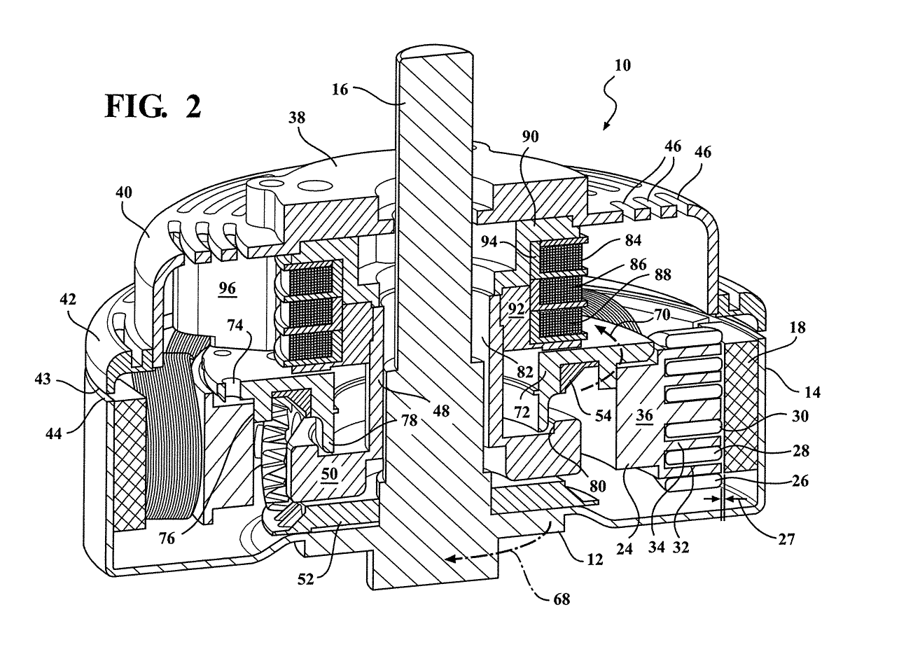

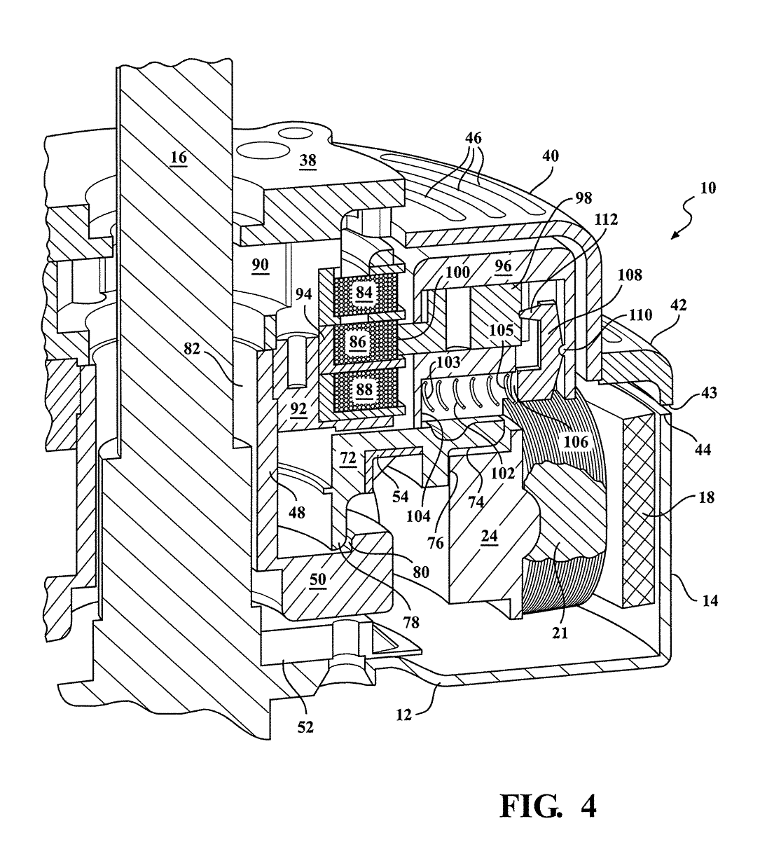

With reference to the above description, and referring initially to the cutaway assembly views of FIGS. 2 and 4, an AC induction electric generator or motor is generally shown at 10 in cutaway fashion (and with each figure depicting both common and varied components of the common assembly in first and second perspective representations). A housing for the assembly includes a reconfigured rotor component, which is exhibited by a circular shaped base 12 with an annular extending end wall 14. A rotatable power output shaft 16 extends upwardly from a center location of the base 12 and, in operation, interfaces with any type of work output component not limited to a gear associated with either a mechanical output or other electrical generator input, and such as is associated with a generator style capacity.

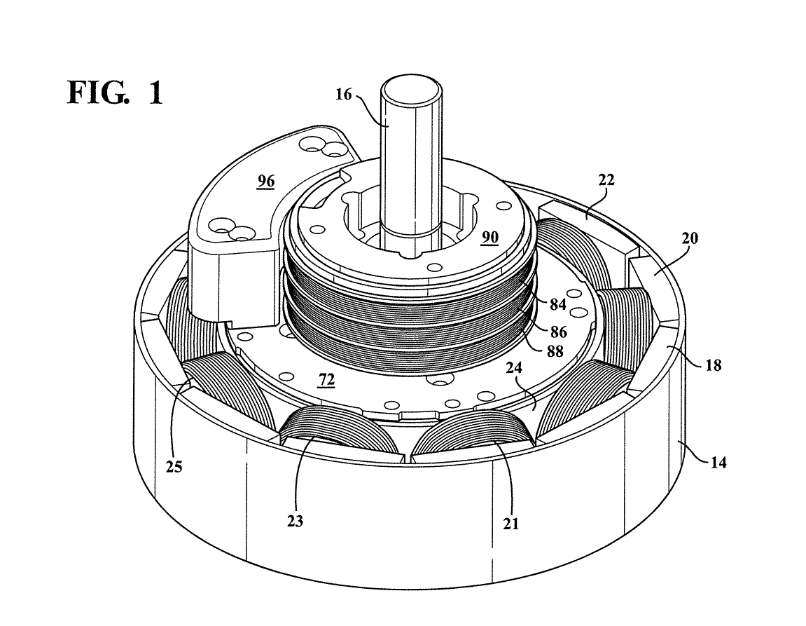

A plurality of magnets 18, 20, 22, et. seq. (see also best shown in FIG. 1) are arranged in circumferential and inwardly facing fashion establishing a first perimeter array about the inner annular surface of the outer end wall 14. Aside from a three dimensional and pseudo-rectangular shape as best depicted in the illustrations, it is further understood that the magnets can be configured in any other shape or profile and can be provided with any variable of magnetic force configuration.

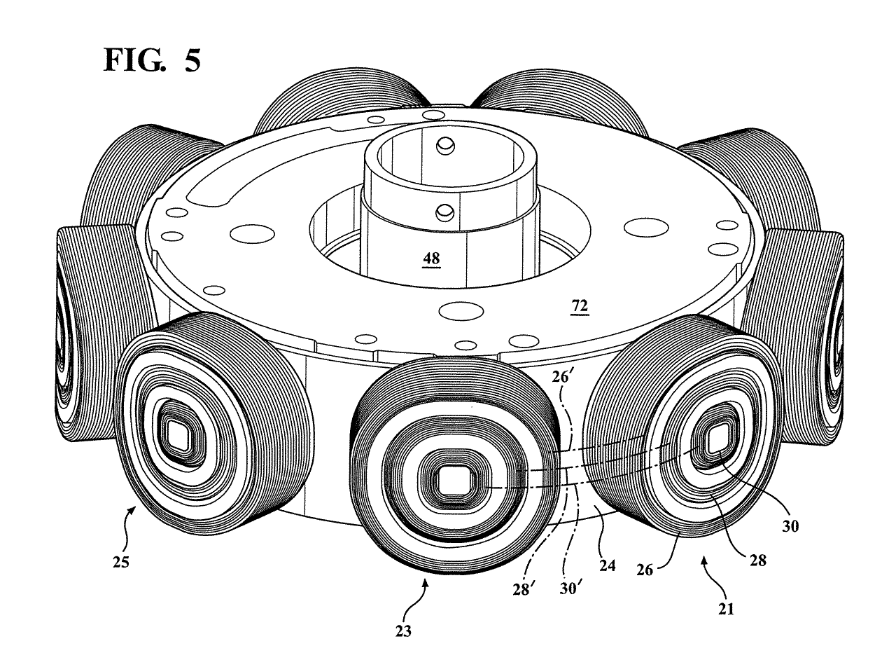

Referencing again FIGS. 2 and 4, a redesign of the (traditionally) stator component includes an interior supported and generally annular shaped structure 24 this being configured in an inner concentric arrangement relative to the outer concentric positioned (and inwardly facing) magnets 18, 20, 22 et seq. supported upon the outer wall 14 of the rotor. As best shown in FIG. 2 when viewed in combination with FIG. 5, a plurality of individual coil subassemblies are shown (nine in the non-limiting illustrated embodiment) arranged in a circumferentially arrayed fashion so as to define a second outwardly facing perimeter array about the annular coil supporting structure 24, and such as are generally represented at each of 21, 23, 25, et seq. in FIG. 5, and which establish a determined gap 27 (FIG. 2) with reference to the inwardly facing first perimeter array of magnets associated with the outer rotating component. The material construction of the inner and outer counter rotating components can include any metallic or other material, such as which can further include any suitable insulating components for ensuring localization of generated magnetic fields in the desired and intended fashion (e.g. commutator, armature brushes, etc.).

The coils can be arranged in a three stage configuration (this facilitating the work output generating in either the generator or motor modes and by virtue of assisting in enhanced magnetic field (and consequent) rotary generating capabilities in application with the outer rotary magnet support component. As shown, a support platform associated with each of the coil subassemblies exhibits (without limitation) a generally three dimensional circular, oval or ellipsoidal shape which is constructed of an insulating material and which is configured for seating a plurality (such as three shown) of concentrically arranged coils as best shown in FIG. 5.

Reference is again made to selected concentric arranged coils 26 (outermost), 28 (intermediate) and 30 (innermost) depicted in a representative subassembly in FIGS. 2 and 5. Additional reference is made to coil receiving concentric pockets 32 and 34 (FIG. 2), these facilitating seating of the intermediate 28 and innermost 30 coils and which, in combination with the outermost concentric positioned coil 26 shown wrapped around the outer annular surface of the insulating platform 36 provide for a three stage configuration of individually insulated coils which can be energized in duration or intensity for varying periods or intervals during the operation of the motor or generator assembly.

One aspect of the present invention contemplates each individual coil (e.g. as previously shown in concentrically arrayed fashion at 26, 28 and 30) exhibiting any multi-wire braiding or winding pattern, the number of wires, configuration of the windings and the like being further understood to contribute to the creation of a desired magnetic field produced profile in the stator-like inner rotatable and wire supporting component which, in combination with the fixed or variable fields generated in the outer concentrically arranged magnets, contributes to the driving of the inner component and counter rotating driving of the outer component (and shaft) in a maximum efficient manner. Without limitation, pluralities of three, five or other wire configurations can be provided for each wound or braided coil, with the gauge or diameter of any one or more given wires being larger than for associated inter-braided wires.

It is also contemplated that the individual coils can be wired together in any combination of inner, middle/intermediate and outer coils (see phantom representations at 26′, 28′ and 30′ in FIG. 5). Alternatively, the concentrically arrayed coils can be combined into a single coil or any other pattern of coil windings not limited to that shown and within the scope of the present inventions.

A stationary component of an outer housing of the assembly includes an upper and annular outwardly extending top surface 38 (FIGS. 2 and 4) which communicates with an intermediate outer annular and curved location 40 and which further terminates in an outermost annular rim 42 exhibiting a downward defined rim edge 43 arranged in close and upwardly spaced proximity to an upper rim edge 44 associated with annular end wall 14 of the outer rotating and magnet array supporting rotor style component. Also shown are heat dissipation slots (see inner perimeter edge defining walls 46) formed in the top 38 along with any other configuration of tab, slot or bracket to facilitate mounting of the housing. Portions 38, 40 and 42 are understood to be stationary relative to 12 and 24 which, as will be further described, counter rotate relative to one another.

As further previously described, the present assembly design differs from the prior art in that the coil supporting (traditionally stator) component, as again depicted by annular structure 24 with supported coil winding patterns 26, 28, 30 et seq., is configured to rotate in a counter or opposite direction to the rotational direction of the magnetically supported outer coaxial housing with annular configured end wall 14, and according to a desired separation (or air gap) between counter-revolving components. The material construction of the various stator and rotor components can include any metallic or other material, such as which can further include any suitable insulating components for ensuring localization of generated magnetic fields in the desired and intended fashion (e.g. commutator, armature brushes, etc.).

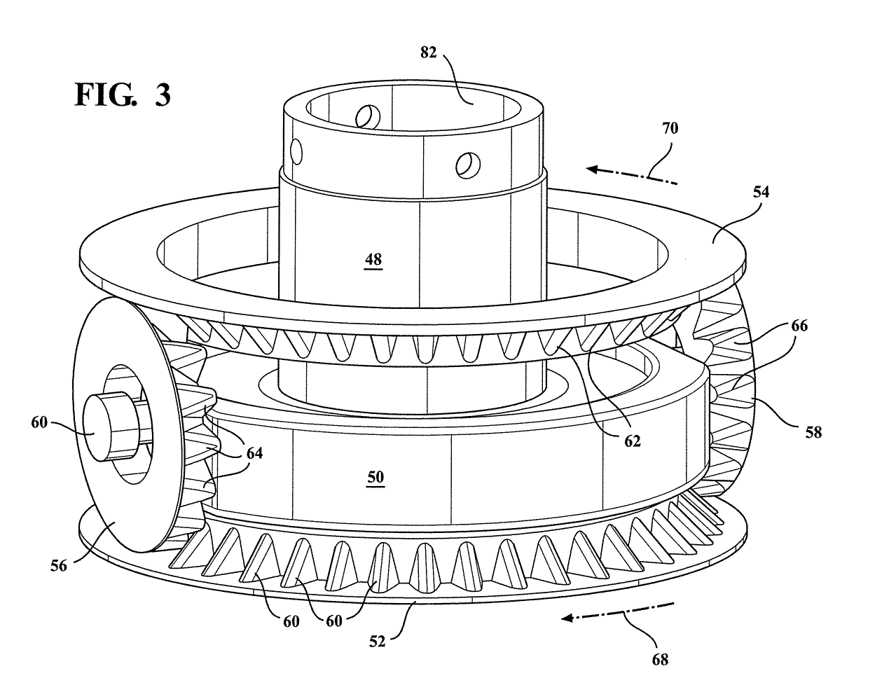

With reference to FIG. 3, a sectional perspective is provided of a gearbox which is integrated into the assembly (see also cutaway perspectives of FIGS. 2 and 4), the gearbox including a main sleeve shaped support trunk 48 with lowermost and outer annular projecting base 50. In combination, a gear subassembly incorporates oppositely driven magnet 52 and coil 54 integrated rings which are spatially supported between a plurality of reversing gears (a pair being shown by representative example at 56 and 58) in order to increase work output, i.e. either enhanced rotation of the shaft in an electric motor mode or increased current output in an electric generator mode.

As shown, each of the gear rings 52 and 54 exhibits a mitre pattern and which includes an angled pattern associated with the plurality of circumferentially arranged teeth 60 encircling the upper surface of the lower magnet component supporting ring 52. Additional circumferentially arrayed teeth 62 are provided about a downwardly facing and opposing surface associated with the upper counter rotating and coil supporting ring 54. The reversing cross configured and interconnecting reversing gears 56 and 58 likewise include similar mitre arrays of teeth, respectively at 64 and 66. The reversing gears 56 and 58 are mounted to interior locations of the housing, see shaft 60 associated with selected gear 56, and respond to an input rotation of the lower magnet ring 52 in a clockwise direction indicated at 68 to counter rotate the coil supporting ring 54 in counterclockwise direction indicated at 70. Without limitation, the teethed patterns depicted on the opposing gear rings can be established at a 1:1 ratio, it being further understood that the number of teeth can further be modified for each ring and in order to vary the rotary speed of the driving magnetic ring 52 relative to the counter driven supporting ring 54.

As again shown in each of the assembly cutaways of FIGS. 2 and 4, the gearbox is incorporated into either of the motor or generator configurations and such that the upper and counter-rotating coil ring 54 is integrated into an annular platform 72 which rotates along with the ring in the referenced counter clockwise fashion at 70. As further shown, the coil ring supporting annular platform 72 includes outer and underside facing support surfaces 74 and 76 which anchor and support the annular structural portion 24 to which the coils are secured and in a joint rotating arrangement.

A further downwardly extending portion 78 of the rotating platform 72 is spaced inwardly of an annular and inner facing lip 80 associated with a configured upper surface of the gearbox base 50 and so that the coil gear ring 54 and integrated platform 72 are supported in a nominally non-contacting fashion during annular rotation. As further shown in FIGS. 2 and 4, the shaft 16 and associated internal base structure of the magnetic supported body 12 are configured so that they extend upwardly through the inner cylindrical surface (at 82) of the gearbox cylinder 48 in a non-contacting fashion.

With reference to the preceding background description regarding conventional brush and commutator arrangements, the present invention incorporates a plurality of commutator segments, see at 84, 86 and 88, which are anchored to the exterior surface of the cylinder 48 of the gearbox, this via additional structural portions 90 and 92 which mount upon the cylinder in an outwardly annular fashion within the interior of the housing. Consistent with prior descriptions, the individual commutator segments are arranged individual annular recessed pockets defined in a suitable insulating material 94 and so as to be insulated from each other as well as the inner concentrically arranged and rotating shaft. Contrasting the prior art descriptions, the commutator segments 84, 86 and 88 are stationary during counter rotation of the outer and inner movable components in the present description.

A brush housing 96 is provided and exhibits a three dimensional and interiorly configured body which is anchored upon a horizontal upper surface of the annular supporting and rotating platform 72 such that the housing 96 rotates along with the coil ring 54 and platform 72 in the counterclockwise manner illustrated. A brush 98 with an inner facing contact surface 100 (see FIG. 4) is provided in contact with selected commutator segment 86 (it further being understood that an additional number of similarly configured brushes may be integrated into the brush housing, such as without limitation in circumferentially offsetting fashion to the selected brush 98 depicted) in a manner in which they contact surface locations of the other commutator segments 84 and 88 in a similar manner).

A spring 102 is further shown in the cutaway of FIG. 4 and is mounted within a pocket defined in the brush housing such that an inner end 103 seats against an inner wall 104, a corresponding outer end 105 of the of the spring 102 abutting and outwardly biasing a lower shoulder 106 of a toggle element 108. A pivot abutment 110 is configured upon an inner facing surface of an outer wall of the housing 96 and about which a midpoint location of the toggle 108 is balanced, with the spring exerted forces resulting in an upper engaging portion 112 of the toggle engaging an outer end surface of the indicated brush 98.

Centrifugal generated forces resulting from higher speed rotations of the brush housing, in combination with the spring forces exerted against the larger (lower) portion of the toggle (by mass) balanced by pivot abutment 110 and represented by contacting end shoulder 106, assist in maintaining a continuous contact profile between the brush and commutator segments and so as to deliver a consistent armature current in either a work input (motor) or electrical output (generator) mode.

The individual wiring arrangements of the coils, in combination with the fixed commutator and rotating outer brush, are engineered to maximize the generation and application of magnetic fields in coils, these interfacing with the opposing magnetic field profile generated by the magnetic elements 18, 20, 22 et seq. in order to generate the driving forces explained in the previous analysis and in order to maximize the driving efficiency of the outer annular supported rotor component relative to the inner and counter rotating coil supporting component in an electric motor application. In the alternate generator application, the efficiencies released by the braiding of the multiple wire armature coil subassemblies results in both enhanced electromagnetic induction generated (EMF) forces resulting from the reversing fields created between the stator and rotor, along with superior collection of the electrical charge created between the coil subassemblies and magnets, further again as a result of the external powered rotating shaft, and which are delivered via the continuous contact profile maintained between the fixed commutator segments 84, 86 and 88 and the outer and continuously contacting brush 98 (again via the inward biasing spring 84).

Without limitation, the novel aspects of the magnetic generator or motor configurations depicted herein include but are not limited to the individual coil winding patterns (such as again which can include any plurality of individually braided wires of similar or varying gauge not limited to examples of the three, five or other pluralities of inter-braided wiring patterns). Furthermore, the concentric and counter-driving arrangement of the inner coaxial coil supporting ring and outer coaxial magnetic component supporting ring is further understood to contribute, along with the coil winding geometries, to the efficiency of the AC magnetic induction motor or generator arrangements.

Notably, the present invention contemplates the driving magnetic gear ring 52 and counter rotated and driven coil gear ring 54 operating in synchronicity with the magnetic fields generated between the coils and magnets in order to enhance the work output established by either the rotating shaft 16 in a motor variant or the current output delivered through an armature (not shown) associated with the brush housing in a generator variant. In this manner, the physical rotation work output or electrical current generating capabilities of the assembly can be increased (up to double) in certain variants. It is also understood and envisioned that other reconfigurations of the outer and inner coaxially arrayed components are contemplated and which will retain or enhance the efficiency of the design.

Having described my invention, other and additional preferred embodiments will become apparent to those skilled in the art to which it pertains, and without deviating from the scope of the appended claims.

I claim:

1. An electromagnet assembly for operating in either of a rotating work or electrical output mode, comprising:
an outer annular arrayed component rotatable in a first direction and an inner annular and concentrically arrayed component rotatable in a second opposite direction, said components separated by an air gap;
said outer component exhibiting an annular end surface supporting a plurality of magnetic elements in a circumferentially extending array, said outer component having a rotatable shaft;
said inner component exhibiting an outwardly facing and circumferentially spaced array of coil-subassemblies opposing said magnetic elements of said outer component;
said coil sub-assemblies each including a plurality of concentrically arrayed coils configured within a platform support of said inner component;
a fixed commutator having a plurality of annular extending and individually insulated segments, a similar plurality of outer rotating brushes in continuous contact with said commutator segments;
said assembly operating in a first variant such that a current supplied to said components creating at least opposing magnetic fields in a desired phased or shifting manner resulting in relative rotation between said components resulting in a rotating work output delivered to said shaft; and
said assembly operating in a second variant such that a rotating work input supplied to said shaft creating at least opposing magnetic fields between said annular components for creating an electrical current output through at least said coil-subassemblies.

2. The invention as described in claim 1, further comprising a gearbox including a sleeve shaped trunk about which are arrayed a pair of upper and lower counter rotating rings, each exhibiting a mitre shaped plurality of teeth, a plurality of reversing gears exhibiting likewise mitre shaped teeth which inter-engage toothed locations of each of said rings.

3. The invention as described in claim 2, further a rotating platform structure within which said upper ring is integrated, a housing incorporating said outer rotating brushes being secured upon said rotating platform structure.

4. The invention as described in claim 3, further comprising a spring biasing each of said brushes in a counter-centrifugal force exerting fashion in order to maintain a continuous contact profile with said commutator segments.

5. The invention as described in claim 4, further comprising a toggle element interposed between said springs and brushes and which is balanced about an abutment defined in said brush housing.

6. The invention as described in claim 1, said outer annular component further comprising a lower housing and said inner annular component an upper housing, said shaft associated with said outer component extending through a central through aperture associated with said inner component.

7. The invention as described in claim 1, each of said coils further comprising a plurality of wires wound or braided together.

8. An electric motor, comprising:
an outer annular arrayed component rotatable in a first direction and an inner annular and concentrically arrayed component rotatable in a second opposite direction, said components separated by an air gap;
said outer component exhibiting an annular end surface supporting a plurality of magnetic elements in a circumferentially extending array, said outer component having a rotatable shaft;
said inner component exhibiting an outwardly facing and circumferentially spaced array of coil-subassemblies opposing said magnetic elements of said outer component;
said coil sub-assemblies each including a plurality of concentrically arrayed coils configured within a platform support of said inner component;
a fixed commutator having a plurality of annular extending and individually insulated segments, a similar plurality of outer rotating brushes in continuous contact with said commutator segments; and
a current supplied to said components creating at least opposing magnetic fields in a desired phased or shifting manner resulting in relative rotation between said components resulting in a rotating work output delivered to said shaft.

9. The invention as described in claim 8, further comprising a gearbox including a sleeve shaped trunk about which are arrayed a pair of upper and lower counter rotating rings, each exhibiting a mitre shaped plurality of teeth, a plurality of reversing gears exhibiting likewise mitre shaped teeth which inter-engage toothed locations of each of said rings.

10. The invention as described in claim 9, further a rotating platform structure within which said upper ring is integrated, a housing incorporating said outer rotating brushes being secured upon said rotating platform structure.

11. The invention as described in claim 10, further comprising a spring biasing each of said brushes in a counter-centrifugal force exerting fashion in order to maintain a continuous contact profile with said commutator segments.

12. The invention as described in claim 11, further comprising a toggle element interposed between said springs and brushes and which is balanced about an abutment defined in said brush housing.

13. The invention as described in claim 8, said outer annular component further comprising a lower housing and said inner annular component an upper housing, said shaft associated with said outer component extending through a central through aperture associated with said inner component.

14. The invention as described in claim 8, each of said coils further comprising a plurality of wires wound or braided together.

15. An electric generator, comprising:
an outer annular arrayed component rotatable in a first direction and an inner annular and concentrically arrayed component rotatable in a second opposite direction, said components separated by an air gap;
said outer component exhibiting an annular end surface supporting a plurality of magnetic elements in a circumferentially extending array, said outer component having a rotatable shaft;
said inner component exhibiting an outwardly facing and circumferentially spaced array of coil-subassemblies opposing said magnetic elements of said outer component;
said coil sub-assemblies each including a plurality of concentrically arrayed coils configured within a platform support of said inner component;
a fixed commutator having a plurality of annular extending and individually insulated segments, a similar plurality of outer rotating brushes in continuous contact with said commutator segments; and
a rotating work input supplied to said shaft creating at least opposing magnetic fields between said annular components for creating an electrical current output through at least said coil subassemblies.

16. The invention as described in claim 15, further comprising a gearbox including a sleeve shaped trunk about which are arrayed a pair of upper and lower counter rotating rings, each exhibiting a mitre shaped plurality of teeth, a plurality of reversing gears exhibiting likewise mitre shaped teeth which inter-engage toothed locations of each of said rings.

17. The invention as described in claim 16, further a rotating platform structure within which said upper ring is integrated, a housing incorporating said outer rotating brushes being secured upon said rotating platform structure.

18. The invention as described in claim 17, further comprising a spring biasing each of said brushes in a counter-centrifugal force exerting fashion in order to maintain a continuous contact profile with said commutator segments.

19. The invention as described in claim 18, further comprising a toggle element interposed between said springs and brushes and which is balanced about an abutment defined in said brush housing.

20. The invention as described in claim 15, said outer annular component further comprising a lower housing and said inner annular component an upper housing, said shaft associated with said outer component extending through a central through aperture associated with said inner component.

21. The invention as described in claim 15, each of said coils further comprising a plurality of wires wound or braided together.
